(19) United States
(12) Patent Application Publication
(10) Pub. No.: US 2006/0281061 A1
(43) Pub. Date: Dec. 14, 2006

(54) Sports Training Simulation System and Associated Methods

(75) Inventors: Keith Hightower, Titusville, FL (US); Randolph L. Perdue, Orlando, FL (US)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(73) Assignee: TGDS, Inc., Titusville, FL (US)

(21) Appl. No.: 11/423,833

(22) Filed: Jun. 13, 2006

Related U.S. Application Data
(60) Provisional application No. 60/690,021, filed on Jun. 13, 2005.

(51) Int. Cl. A63B 69/00; G09B 9/00

(52) U.S. Cl. 434/247

(57) ABSTRACT

A simulation system for training athletes in cognitive skills includes hardware incorporating imaging and tracking devices, sound generator and receiver, a projection screen, and a movie projector for creating a virtual environment that simulates the site specific to the sport. The system includes software installed on a processor that is in signal communication and in controlling relation to the hardware elements. The system inputs to the software a plurality of scenarios in which the athlete might find him/herself. The software acts to retrieve a scenario and output a plurality of control signals for presenting a visual and aural simulation. A body parameter is tracked in temporal coordination with elements of the scenario. The tracked parameter is saved for later review by the user and, in some cases, training personnel. The scenario evolves in response to the tracked parameter, and is thus interactive in nature.

### CROSS-REFERENCE TO RELATED APPLICATION

This application claims priority to provisional application Ser. No. 60/690,021, filed Jun. 13, 2005, entitled “Sports Training Simulation System and Associated Methods.”

### BACKGROUND OF THE INVENTION

1. Field of the Invention

The present invention relates to systems and methods for training athletes, and, more particularly, to such systems and methods that incorporate automated, interactive features.

2. Description of Related Art

It is known in the art to use simulation systems in training for various professions, such as airline pilots. Such systems, however, tend to receive input in the form of user actions with regard to equipment in a certain scenario, and do not monitor user body position.

It is also known to use some forms of simulation and body modeling in training athletes, such as golfers, track and field athletes, and tennis players.

In team sports, however, reactions can be required to actions of other team members and a plurality of opponents, and plays formulated and executed. Training for such activities has been until now accomplished via live drills.

It would therefore be advantageous to provide a system and method for training athletes who are team members and who routinely perform actions requiring a great deal of movement.

In the particular situation of football quarterbacks, most players entering the NFL are at or near their peak physical conditioning. What separates the great players from the average players is the ability to assimilate information and make the appropriate adjustments quickly.

The game of football is continually evolving, with the advantage moving back and forth between offense and defense. New quarterbacks entering the NFL are expected to produce positive results in their rookie year. Two of the hardest and most time-consuming tasks a new quarterback has to master are learning a team's offensive system and reading defenses. Traditional methods used to teach new quarterbacks a team's offensive system are reading paper copies of playbooks, reviewing films, and team scrimmages.

Teaching new quarterbacks how to read defenses is an even more time-consuming and manpower-intensive task. Learning to properly read defenses and make the proper adjustments can take years.

With players continually becoming faster and stronger, the risk of injuries is always high. If a team's starting quarterback is injured or cannot start for some other reason, a heavy burden is placed on the backup quarterback. Many games have been lost because an untested quarterback has had to step in for an injured starting quarterback.

New methods are required to accelerate and improve the learning process for quarterbacks.

### SUMMARY OF THE INVENTION

The present invention is directed to a simulation system and method for training athletes in cognitive skills. The system includes hardware incorporating imaging and tracking devices, such as a processor, a sound generator and receiver, a projection screen, and a movie projector. The hardware is adapted to create a virtual environment that simulates the site specific to the desired sport. One of skill in the art will appreciate that other hardware elements could be incorporated into the system, such as a display screen in signal communication with the processor.

The system further includes a software package installed on the processor that is in signal communication and in controlling relation to the other hardware elements of the system. The system additionally includes an input for entering into the software a plurality of scenarios in which the athlete might find him/herself, such as in a database accessible by the processor.

The software acts to retrieve a scenario from the input means and output a plurality of control signals for presenting to the user a visual and aural simulation of the scenario. At least one user body parameter is tracked, for example, head motion or vocal responses, in temporal coordination with elements of the scenario presented. The tracked parameter can be saved for later review by the user and, in some cases, training personnel such as a coach. The scenario evolves in response to the tracked parameter, and is thus interactive in nature.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 schematically illustrates the three components of the quarterback training system of the present invention.

FIG. 2 is a schematic diagram of a user outfitted for using the system.

FIG. 3 is an exemplary system schematic for training a football quarterback.

FIG. 4 is an flowchart outlining exemplary steps in carrying out a method of the invention.

### DETAILED DESCRIPTION OF THE PREFERRED EMBODIMENTS

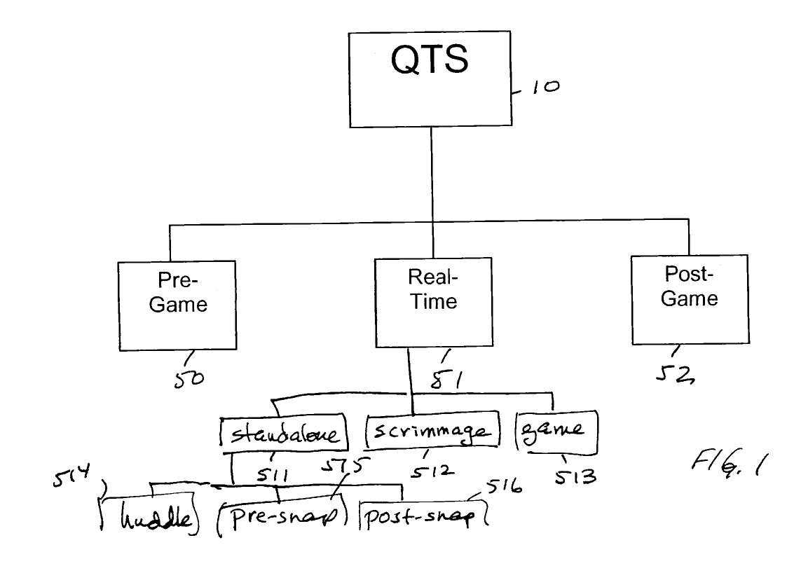

A description of the preferred embodiments of the present invention will now be presented with reference to FIGS. 1-4.

Exemplary embodiments of the invention will be presented for training a football quarterback or for permitting a user to role-play. Simulation technology can be used to accelerate and improve quarterback training tasks. One of skill in the art will recognize that this embodiment is not intended to be limiting, and that the system is usable in any number of settings for a variety of sports.

When used by a quarterback being trained, the system provides a real-time “man-in-the-loop” system that improves cognitive decision-making under stress. The system 10 includes audio, visual, and computational subsystems that when integrated together immerse the quarterback in a virtual world. The system can also be configured to run faster than real time, for improving reaction time in the quarterback to evolving scenarios.

In an exemplary embodiment (FIG. 3), the system 10 comprises a processor 53, a display screen 24, a projector 19, a database 54 accessible by the processor, a workstation 55 having an input 56 in communication therewith for use by a coordinator 57 in communication with the processor. Software 58 is resident on the processor 53 for performing the calculations and hardware control to be outlined in the following.

The system 10 provides a quarterback with tools and an environment to learn new offensive plays and systems, improve “defense recognition” skills, improve “defense adaptation” skills, and perform “mission rehearsal” against an upcoming opponent. The system 10 further provides a coaching staff with tools to generate an electronic version of offensive playbook, review and critique performance after a training session, and generate a desired simulated scenario, for example, having a ball on the 25 yard line, two minutes left, with one time out.

The quarterback training system 10 (QTS) of the present invention can comprise three modules. The first component is a pre-game module 50. The pre-game module 50 comprises an offline set of tools that provides the coaching staff with tools to generate offensive playbooks, defensive playbooks, and game scenarios. The second component of QTS is a real-time(or faster) module 51. The real-time module 51 comprises a virtual world that utilizes the playbooks and scenarios generated in the pre-game module 50 to train the quarterback. The third component of QTS comprises a post-game module 52. The post-game module 52 comprises a tool the coaching staff can use to review a training session (see FIG. 1).

Pre-Game Module. The offensive play generation tool (OPGT) is used to generate an electronic version of the team's offensive playbook. The OPGT software provides the user with a graphical user interface and tool sets. The graphical user interface may be controlled with any one or more of the following: mouse, touch screen, and touch pen (non-marking pen), or other device known in the art. Player icons are provided, in pallets located on each side of the screen. During play generation mode a generic football field is used as background. This background has yard lines and hash marks.

The OPGT tool set allows a member of the coaching staff to: identify the play with a unique name, assign the play to a group, draw the play graphically, assign each player an assignment (e.g., blocking, route, etc.), and run the newly created play.

During the playback or play review mode the coach can review the newly created offensive play from any angle. The playback mode allows the coach to verify that each player's assignment is correct. The OPGT provides the capability to group similar-type plays together for ease of bookkeeping, i.e., run, pass, etc. The “electronic playbook” is encrypted and stored on a drive accessible by the processor.

For security, the system 10 may utilize, for example, an eToken USB-based two-factor authentication on a dedicated laptop computer to protect the integrity and security of a team's playbook. The online mode preferably cannot access the run-time playbook data files without the proper token.

The defensive play generation tool (DPGT) is used to generate an electronic version of any team's defensive playbook. The DPGT software provides the user with a graphical user interface and tool sets. The graphical user interface may be controlled with any one or more of the following: mouse, touch screen, and touch pen (non-marking pen), or any other device known by one of skill in the art. Player icons are provided, in pallets located on each side of the screen. The DPGT tool set allows a member of the coaching staff to: identify the play with a unique name, assign the play to a group, draw the play graphically, and assign each player an assignment. The electronic playbook is stored on a shared system drive that is accessible from any system within the system. The electronic playbook is encrypted for security purposes. Access to this in either the offline or online mode requires encryption keys and passwords.

The scenario generation tool (SGT) provides coaching staff with tools to build pre-defined scenarios, e.g., 2-minute warning, behind 3 points, ball on 25 yard line, 2 timeouts. These scenarios are used to put the quarterback in specific stressful game situations. Each scenario is “linked” to a specific offensive and defensive playbook. Scenarios may be described with the following attributes: score, “line of scrimmage” location, “play clock.” “game clock,” lighting, temperature, precipitation, footing, number of time outs.

Scenarios can be built to simulate a virtual season for “mission rehearsal” type training. Scenarios can be built to provide a structured training syllabus taking the quarterback from elementary skills to progressively higher-level skills. The electronic scenarios can be stored on a database or shared system drive that is accessible from any element within the invention.

Real Time (Standalone/Scrimmage/Game). In the real-time module the quarterback interacts with the virtual world to learn the offensive system and improve decision-making skills. The real-time module 51 comprises several sub-modules: standalone 511, scrimmage 512, and game 513. Preferably the response time of the present system is less than 150 ms, and most preferably, in a range of 50 ms. Also preferably the system 10 can be configured to run faster than real time.

During the initial stages of training, the quarterback can use the “standalone” module 511. The quarterback can be immersed in a virtual world with a plurality of, for example, ten, virtual offensive players. The quarterback is able to call any play in the electronic playbook. Each virtual offensive player reacts accordingly. The quarterback is provided visual cues available on the visual display system (VDS). These visual cues are similar to the “heads-up display” (HUD) technology used in military weapons systems. Visual cues such as blinking indicia can highlight the primary, secondary, and tertiary receivers and or runners. Further, other visual cues can display indicia indicative of a probable outcome of the quarterback's action.

During the intermediate stages of training, the “scrimmage” module 512 can be used to train the quarterback. The “scrimmage” module has all the capabilities of the “standalone” module 511; however, in this module a generic virtual defense is provided. The scrimmage module 512 is typically used once the quarterback is familiar with the offensive system. The quarterback is immersed in a virtual world with ten virtual offensive players and eleven virtual defensive players. This represents a generally “low-stress” module. A virtual defense is present; however, the level of defensive play is low. Virtual defensive players can get in the way and perform “tricks.” Offensive miscues are disabled in this module. The scrimmage module 512 requires a full-up system with both the OCS and DCS stations being manned.

The “full up” of training is conducted in the “game” module 513, which immerses the quarterback in a highly realistic virtual world of football simulation. The “game” module 513 can be viewed as “mission rehearsal” for the next game, for example. The defense team adapts to the offensive team based on the limitations and techniques defined in the defensive playbook. The defense can use a “trick” to confuse the quarterback. Active offensive miscues are enabled. This feature provides for missing blocking assignments and route assignments. Pre-defined scenarios can be used to place the quarterback in stressful situations. The quarterback has to recognize, react, and adapt to what the virtual defense presents. This module typically requires a full-up system with both the OCS and DCS stations being manned.

The real-time sub-modules 511-513 can be divided into three phases: huddle 514, pre-snap 515, and post-snap 516. The huddle 514 is where the play is called. In the pre-snap phase 515 the quarterback and virtual players are at the line of scrimmage and are interacting with the virtual world. This phase is likely to be where a significant portion of the cognitive training occurs. The quarterback is expected to review the defensive formation and react and adapt accordingly. The quarterback can call an audible during this phase.

The snap is a transitory event triggered by the quarterback with an aural cue as defined in the offensive playback or redefined by the quarterback in the huddle phase 514.

When the snap is triggered by the quarterback, the post-snap phase 516 is entered. During the post-snap 516, after the pass is thrown or ball is handed off, the action is in the virtual world. The quarterback typically does not interact with the training system after this point.

In the virtual entities of the system 10, virtual offensive and defensive player interactions are based on physical principles to ensure realistic outcomes to “man-on-man” match-ups. Each virtual offensive and defensive player can have the attributes of height, weight, speed, strength, fatigue, and mental skill. The “fatigue” attribute may be altered in real-time by the OC and/or DC.

In the offense, ten offensive players are modeled. Each virtual player is controlled by the computational host 53,58. Offensive players react to an audible called by the quarterback. In the defense, eleven defensive players are modeled. Each defensive player is controlled as an independent entity by the computational host 53,58. Behavior is determined by the defensive play called and the dynamic interaction with the offensive players and the quarterback. The invention allows for the OC and DC to select any virtual player and dynamically change the default behavior such as force a penalty or missed tackle, as examples. This behavior override can be a single shot (for the next play only) or continuous (for the remainder of the game or the behavior is disabled).

All referees are preferably modeled, with each referee being controlled by the computational host 53,58. Referees will generally only be visible during the real-time game sub-module 513. Referees can whistle play dead, stop and/or start the play clock, and signal a penalty.

The play clock is driven by the computational host 53,58 and controlled by the OC at the OCS or the referees. A simulated play clock is displayed at each end of the virtual field. A simulated game clock is displayed in one end zone.

Yardage markers and hash marks are dynamically changed depending upon where on the field the play will be run. During the real-time game module 513 the first down stakes are dynamically changed to reflect the results of the most recently completed play.

A role player is a “man-in-the-loop” participant. The system 10 allows for the addition of role players to the game scenario. From the OCS for offensive players or the DCS for defensive players, role players can be defined and activated. Any position, whether offense, defense, or an official, is supported. High-definition role players are achieved by using multiple domes networked together to allow for multiple trainers to operate in a distributed game training module (DGT). A special uniform that monitors body positions is an option that can allow the role player's arm, leg, head, and back motions to be accurately replicated at other domes. Microphones 20 provide for the role player's voice to blend with the quarterback. Voice pitch reconstruction allows the role player's voice to be altered to affect training.

An optional “low-fidelity” role player virtual football man (VFM) is available. The VFM comprises a basic computer having keyboard, mouse or joysticks, and microphones. A display device allows the VFM role player a visual representation of the game environment.

The invention allows for the OCS and DCS to resume real-time game sub-module 513 play to any previous play in the game sequence. This allows the quarterback to repeat a sequence of plays.

Post-Game. During each stage of training, the quarterback and coaching staff can use a post-play review system 52 (PPRS) to review quarterback performance. The PPRS 52 digitally records every play of the training scenario for a post-training session debrief by coaches and quarterback trainees. “Zoom in” and “zoom out” are provided, as well as the ability to pause a play, adjust playback speed, and select a “viewing perspective” (i.e., side, top, front, back). The offline (post-play review) configuration is used to review a previously recorded training session. The PPRS 52 can be run from a standalone PC. A member of the coaching staff, along with a quarterback, may use the PPRS 52 to review a recent training session.

Real-Time System Device Descriptions. The invention can also include a virtual football arena, which comprises the virtual quarterback instruction area. This area comprises a raised floor on with a surface, for example, Astroturf, to simulate a football playing field. The arena consists of two regions: play and safety. An exemplary play area is 45 feet on the front or the line of scrimmage. The pocket area is 30 feet deep. The safety area is 15 feet on each side of the play area. The area is covered with an acoustically sensitive fabric. A false ceiling is 12 feet high for hiding the camera 21, projectors 19, and microphones 20. The motion detection equipment is integrated into the Astroturf. A rear entrance is how the student enters the arena, with the door being closed to provide for an acoustically accurate environment. The virtual football arena can include a programmable environmental system that can control the ambient air temperature from 48 to 92° F. The virtual football arena has surveillance cameras for the benefit of the instructors to monitor and record training exercise. Digitally recorded video data from cameras are used by the PPRS. The system supports real-time positioning control and an automatic module to position to predefined positions and optional video recording.

The invention allows for the collection of statistical data during the real-time module 51. These data are stored. A report function to monitor the quarterback's progress is provided to include, but is not intended to be limited to: playback proficiency, pass defense understanding, pass receiver identification, and calling audibles. When running a virtual season scenario, similar statistics are maintained as for an actual season.

Offensive Coordinator Station (OCS). The OCS 22 is a computerized system that provides the instructor/coordinator with a tool to control the virtual simulation world. The software, running on the OCS 22, provides the instructor/coordinator with a graphical user interface. The instructor/coordinator navigates the OCS 22 by pressing buttons, rotating radio type buttons, and moving sliders. “Back” buttons are provided on each page so instructor/coordinator can navigate backwards to previously displayed pages. The graphical user interface may be controlled with a mouse, touch pen, and/or a touch screen. The “offensive electronic playbook” is accessible on the OCS 22.

Graphical presentations are provided for, for example, starting and stopping training, initialization of training systems, offensive play selection, game clock manipulation, play clock manipulation, scenario selection, offensive miscues (malfunctions), penalty injections, weather selection, crowd noise manipulation, virtual offensive player attribute manipulation, and enabling the trainee assist symbology.

Defensive Coordinator Station (DCS). The DCS 23 is a computerized system that provides the defensive instructor/coordinator with a tool to control the virtual simulation world. The software, running on the DCS 23, provides the instructor/coordinator with a graphical user interface. The instructor/coordinator navigates the DCS 23 by pressing buttons, rotating radio-type buttons, and moving sliders. “Back” buttons are provided on each page so instructor/coordinator can navigate backwards to previously displayed pages.

The graphical user interface may be controlled, for example, with a mouse, touch pen and/or a touch screen. The “defensive electronic playbook” is accessible on the DCS 23.

Graphical presentations are provided for, for example, starting and stopping training, initialization of training systems, defensive play selection, game clock manipulation, play clock manipulation, scenario selection, penalty injections, weather selection, crowd noise manipulation, and virtual offensive player attribute manipulation.

Voice Recognition System (VREGS). When the VREGS is enabled at the OCS 23, the athlete can enable key functions to enhance the training experience. For example, a code word, SYMBOL, toggles the interactive symbology.

Image Generator (IG). The IG can render (or draw) virtual players, crowd, stadium, clocks, symbology, and playing field, for example. The IG uses the motion detection system (MDS) and head tracking system (HTS) data to determine the quarterback's viewpoint. Based on the quarterback's viewpoint, the IG renders an image that is then displayed on the VDS.

Video Display System (VDS). The VDS comprises projectors 19 and screens 20 (FIG. 3), the projectors 19 for displaying images and symbology, rendered by the IG, on screens 24, and the display screen comprising three panels covering, for example, a 180-degree field of view (FOV).

Inserted into the gaming scene are special symbols superimposed on the virtual modules to identify key events to the quarterback.

| Offensive Player Queues | Effects | Update Rate | Symbol |
|---|---|---|---|
| Primary Receiver | Blinks | 2 Hz | Asterisks |
| Secondary Receiver | Blinks | 1 Hz | Diamond |
| Tertiary Receiver | Blinks | 0.5 Hz | Square |
| Eligible Receiver | Highlights | N/A | Circle |

Note: Symbols are located at the top of the VDS and follow the receiver. Defensive player queues, for example, include situations in which defensive back coverage prevents successful completion or a defensive lineman blocks a pass. Pass queues, for example, include situations such as interceptions and completions. This function can be enabled by the OCS or via the VREGS function code word SYMBOL. The VREGS can be disabled at the OCS.

Feedback from the voice engine allows detection of commands from the quarterback.

Aural Cue (ACS). The ACS generates realistic sounds in the QTS by generating “surround” sound within a training room. The sounds generated may include crowd noise, offensive teammate dialogue at line-of-scrimmage, defensive player noise, coach's dialogue, and player impact noise.

Computational Host (Host). The host 53 is the “heart” of the system 10. The host 53 can, for example, interface to all other computer sub-systems, drive all (21) offensive and defensive virtual players, drive game and play clocks, and provide real-time runs at 60 Hz. An exemplary table of data handled by the computational host is listed in the following:

| Data | Source | Destination | Rate |
|---|---|---|---|
| Crowd Sounds | ACS | Sound System | 30 Hz |
| Player Sounds | ACS | Sound System | 30 HZ |
| Sound Triggers | Host | ACS | 30 Hz |
| QB Line-of-Sight | HTS | Host | 60 Hz |
| Offensive Play | OCS | Host | Asynchronous |
| Offensive Miscues | OCS | Host | Asynchronous |
| Weather Attributes | OCS | Host | Asynchronous |
| Penalties | OCS | Host | Asynchronous |
| Play start | OCS | Host | Asynchronous |
| Defensive Play | DCS | Host | Asynchronous |
| Defensive Miscues | DCS | Host | Asynchronous |
| QB FOV (derived from | Host | IG | 60 Hz |
| LOS & MDS data) | | | |
| QB Pointing Angles | Host | IG | 60 Hz |
| Offensive Player States (10) | Host | IG | 60 Hz |
| Defensive Player States (11) | Host | IG | 60 Hz |
| Referee States | Host | IG | 60 Hz |
| Game-clock | Host | IG | 60 Hz |
| Play-clock | Host | IG | 60 Hz |
| Video | IG | VDS | 60 Hz |
| IG Status | IG | Host | 60 Hz |
| Voice Data | QB | VREGS | 60 Hz |
| QB Location | MDS | Host | 60 H |
| QB Line of Sight (LOS) | HTS | Host | 60 Hz |

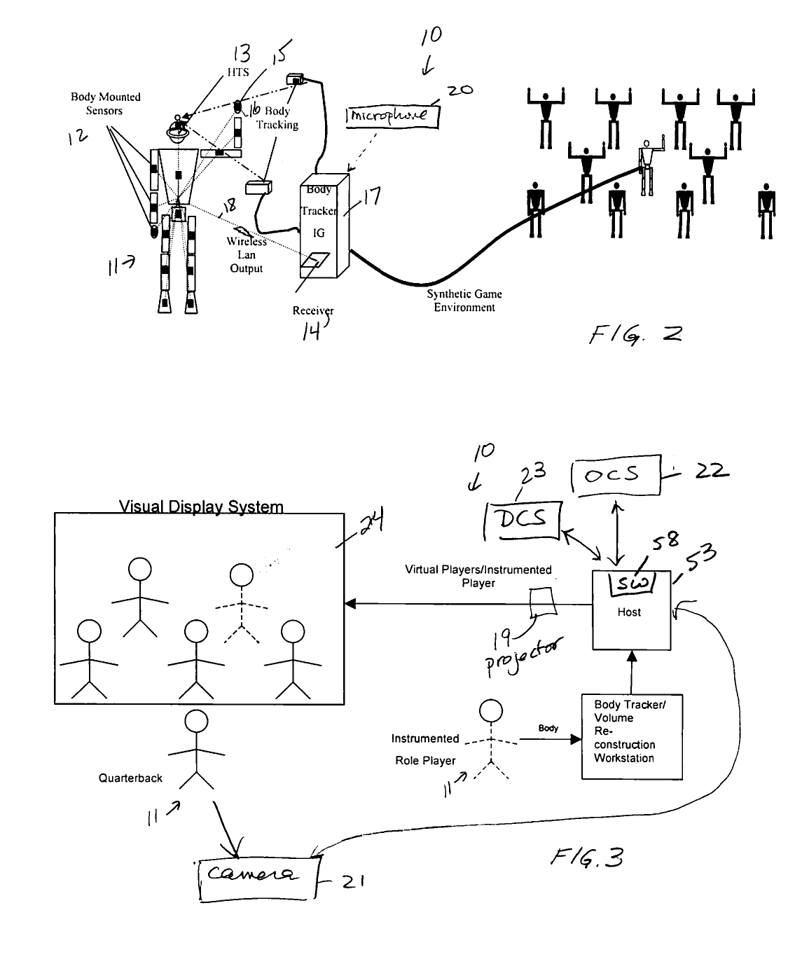

Sensors. The user, here, the quarterback/trainee/role-player 11, is provided with a plurality of sensors 12 (FIG. 2). For example, the head tracker system 13 (HTS) can be a helmet-mounted wireless system that transmits the location to a receiver 14 where the quarterback trainee 11 is currently looking to the host. Feedback from the head tracker enable queues based on quarterback current FOV.

A virtual football glove device 15 can be worn by the user 11 on his passing hand 16. The device 15 can detect an aim point based on a nominal calibration on the heel of his hand 16. A wireless transmitter on the glove 15 sends azimuth and elevation to a base receiver station 14. The base receiver station 14 has an external interface for communication to the host computer 17.

Devices 12 fitted to a standard football uniform or any pant and shirt combination can be used as a virtual football uniform. The devices 12 record the position of the player's arms, legs, back, and head. These data are sent to a base station 14 via a wireless connection 18. The dynamic inputs coupled with the off-line adaptation data for the student quarterback, such as ball velocity and throwing distance, determine the behavior or the interactive symbology.

With the use of an instrumented equipment base station, the base station 14 receives updates from the instrumented uniform. These data are available to the host computer 17 over standard communication devices using a specially designed virtual football network protocol, for example.

A motion detection system (MDS) tracks the location of the quarterback within the training area. This location data are provided to the host. The host provides the location data along with the HTS data to the IG. The IG uses the MDS and HTS data to determine the quarterback's viewpoint. The student quarterback's use of nonverbal body motion cues (stopping of a foot) to his offensive teammates can be detected via the motion detection system and used to begin offense prior to snap player movements.

A warning, caution, or alert is a programmable event during the motion sequence based in a pre-defined sequence of events. A warning preferably causes a variable audio alert. A caution preferably causes a variable audio and visual alert. An alert preferably causes the simulation to freeze.

A pre-defined area on the staging area represents the quarterback pocket. This area is tied to a specific play. Based on the motion detection of the quarterback, a warning caution alert (WCA) is generated to inform the quarterback that the pocket has been violated.

The safety zone is a predefined area on the staging area that can cause an alert, and cannot be disabled. The safety zone represents a fail safe to prevent the quarterback from becoming injured if the game sequence shifts out of the staging area.

Intercom System (ICS). The ICS serves as a communication channel between the OC and the quarterback; private communication channels between the OC and DC, in order to allow the OC and DC to setup scenarios to stress the quarterback; and communication channels for maintenance personnel.

Instrumented Player. Preferably the quarterback student has a head tracker and a passing hand tracker. The motion capture is required to support the cues needed to allow for identification of primary and secondary receivers. Furthermore, the probability of a completion (POC) and the probability of intercept (POI) require both the head tracker and passing hand tracker information.

Role Players. The role-player embodiment gives the student quarterback a real-world environment for team-specific game rehearsals, stress management, and specialized offensive teammate coordination practice.

The goal of the defensive role player is to provide “stress” training that is not available otherwise. The technology can perform “body tracking” and “voice reconstruction” for insertion into the simulated gaming environment. The role player body movement can be converted into computer animation in real-time using a combination of passive and active sensors attached to the role players uniform. The role player's voice can be captured and inserted into the simulated gaming environment. The physical attributes of the role player can be modified such that he or she appears at any physical height or weight.

The role player's voice content can be recorded and repeated into the simulated gaming environment in real time. The role player's speech characteristics can be morphed into another given personality. The OC or DC, whoever is in control of the role player, can control the voice conversion options.

The goal of the offensive role player is to provide coordination between the student quarterback and an offensive role player.

During the real-time game module 513 a real player can be instrumented to send visual signals to the quarterback trainee. Such a real player may comprise, for example, a backup quarterback. The instrumented player can be physically located near the OC. His virtual image, along with his movements, can be displayed, on the sidelines, on the visual display system. This capability provides the backup quarterback training in the visual signals the coaching staff wants to use for an upcoming game. Furthermore, the quarterback trainee, in the virtual football arena, thereby can learn the new visual signals.

It can be seen that the system and methods of the present invention are readily adaptable beyond the game of football, a detailed description of which is presented herein as exemplary and not intended to be limiting.

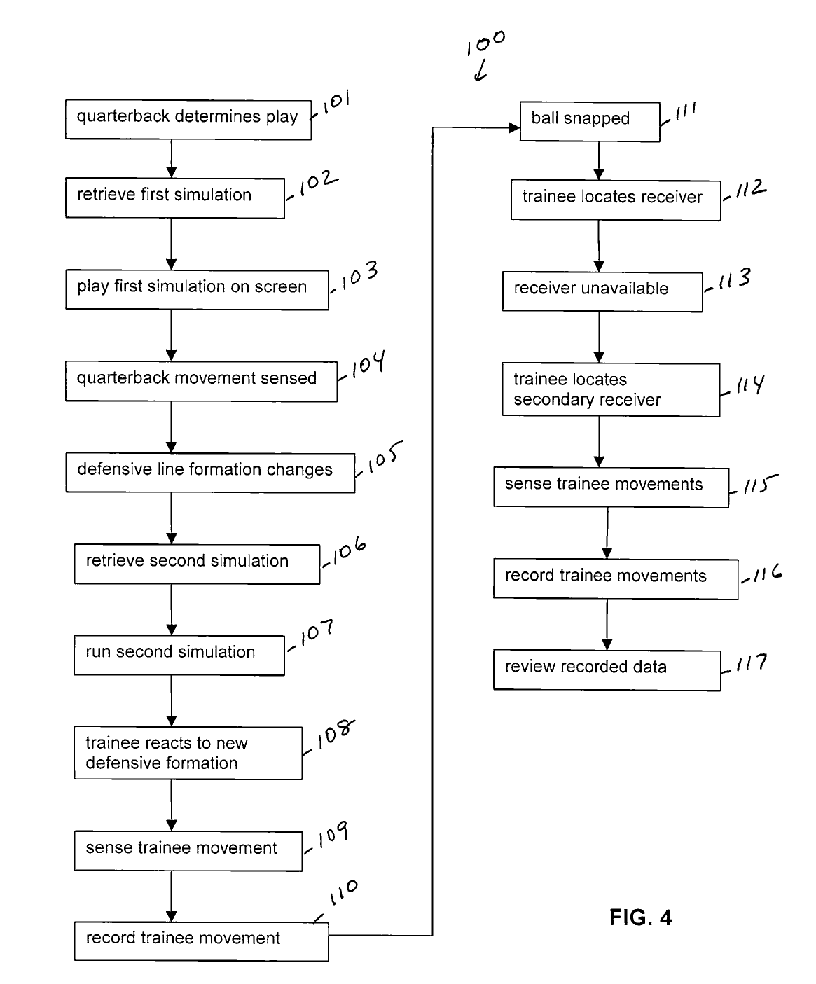

Exemplary Simulation. FIG. 4 is a flowchart outlining an exemplary simulation sequence 100 undergone by a quarterback trainee. In this simulation 100 the trainee is in the real-time game module 513, with a defensive coordinator 23 interacting with the system 10. A play is determined by the quarterback (block 101), and the first simulation correlated to that play is retrieved from the database (block 102) and played on the display screen (block 103). The first simulation will include the defensive formation, for example. Responsive to a perceived movement of the quarterback (block 104), the defensive coordinator 23 signals for a change in formation of the defensive line (block 105), which comprises a second simulation. The second simulation is retrieved (block 106) and run (block 107), and the trainee must react to the new defensive formation (block 108), which may include calling an audible, for example. The trainee's movements are sensed (block 109) and recorded (block 110).

After the ball is snapped (block 111), a first receiver is located visually by the trainee (block 112). In some embodiments the first receiver may be highlighted with indicia adjacent his position. If the first receiver becomes unavailable owing to error or defensive play (block 113), the trainee must locate a secondary receiver (block 114). Again, the second receiver may be highlighted with indicia on the screen. The trainee's movements are sensed (block 115) and recorded (block 116). Other “faults” by the virtual offensive and/or defensive players may also be included in the simulations that the quarterback trainee must respond to, such as missed blocking assignments or pass route assignments.

In some embodiments the trainee may be able to throw an actual football, the movements of which are also sensed and correlated with the positions of the receivers. A play clock is also visible by the trainee for tracking elapsed time of the play, and a game clock is further visible.

In either or both cases, the system 10 may also display indicia on the screen indicative of a probable outcome of the trainee's actions. In addition, the plays made by the trainee can be reviewed (block 117) in the post-game module 52.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction and use.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

What is claimed is:

1. A sports training system comprising:
a processor;
a display screen;
a sensor in signal communication with the processor, the sensor affixable to a body portion of a trainee adapted to output an indicator of a position of the trainee body portion;
a coordinator input in signal communication with the processor operable by a human coordinator;
a database accessible by the processor containing a plurality of game play and play setup simulations; and
software resident on the processor having code segments adapted to:
receive a signal from the coordinator input designating a desired first simulation to be run;
retrieve the desired first simulation from the database;
play the retrieved first simulation on the display screen;
monitor sensor output indicative of trainee first movement;
receive a signal from the coordinator input designating a second desired simulation to be run, the second desired simulation selected by the coordinator responsive to the trainee first movement;
retrieve the second desired simulation from the database;
play the retrieved second simulation on the display screen; and
monitor sensor output indicative of trainee second movement responsive to the played second simulation.

2. The sports training system recited in claim 1, wherein the sensor is adapted to monitor at least one of a trainee physical parameter including head movement, eye movement, throwing arm movement, and leg movement.

3. The sports training system recited in claim 2, wherein the trainee comprises a football quarterback trainee initiating a first play, the coordinator comprises a defensive coordinator, the first simulation comprises a first defensive line configuration, and the second simulation comprises a second defensive line configuration selected responsive to the monitored trainee physical parameter.

4. The sports training system recited in claim 1, wherein the trainee comprises a football quarterback trainee initiating a first play, the coordinator comprises an offensive coordinator, the first simulation comprises a first defensive line configuration, and the second simulation comprises a defensive player movement and an offensive receiver movement.

5. The sports training system recited in claim 4, wherein the offensive receiver movement includes a play error, and the second simulation further comprises a second offensive receiver movement.

6. The sports training system recited in claim 4, wherein the second simulation includes a tackling of the offensive receiver and a second offensive receiver movement.

7. The sports training system recited in claim 1, wherein the trainee comprises a football quarterback trainee initiating a first play, the coordinator comprises at least one of an offensive coordinator and a defensive coordinator, the first simulation comprises at least one of a first defensive line configuration and a second defensive line configuration, and the second simulation comprises a defensive player movement and an offensive player movement.

8. The sports training system recited in claim 7, wherein at least one of the offensive receiver movement and the defensive player movement includes a play error, and the trainee second movement comprises a response to the play error.

9. The sports training system recited in claim 1, further comprising a trainee microphone in signal communication with the processor positioned for receiving oral input from the trainee, the oral input responsive to the second simulation.

10. The sports training system recited in claim 1, wherein at least one of the first and the second simulation are playable at speeds faster than real time.

11. The sports training system recited in claim 1, wherein the software further has a code segment adapted to impose indicia on the display screen for assisting in tracking a particular simulated player.

12. The sports training system recited in claim 1, wherein the software further has a code segment adapted to impose indicia on the display screen indicative of a probable consequence of the trainee first and second movement.

13. The sports training system recited in claim 1, further comprising a sensor in signal communication with the processor between the trainee and the display screen, for detecting a position of a thrown football.

14. The sports training system recited in claim 1, wherein the processor further comprises a timer, and the software further has code segments adapted to track a duration of a simulation and to display a simulated play clock on the display screen.

15. The sports training system recited in claim 1, further comprising a storage device in signal communication with the processor, and wherein the software further has a code segment adapted to record trainee sensor output for permitting subsequent review of a simulation.
